(19) United States
(12) Patent Application Publication
(10) Pub. No.: US 2015/0286531 A1
(43) Pub. Date: Oct. 8, 2015

(54) RAID STORAGE PROCESSING

(71) Applicant: HEWLETT-PACKARD DEVELOPMENT COMPANY, L.P., Houston, TX (US)

(72) Inventor: Matthew David Bondurant, Boulder, CO (US)

(21) Appl. No.: 14/433,668

(22) PCT Filed: Dec. 20, 2012
(86) PCT No.: PCT/US2012/070963

§ 371 Date: Apr. 5, 2015

(51) Int. Cl. G06F 11/10

(52) U.S. Cl. CPC G06F 11/1092; G06F 11/1096

(57) ABSTRACT

A storage system to process storage that includes a storage management module and a plurality of redundant array of independent disks (RAID) storage groups that includes storage drives to have a plurality of redundancy levels. The storage management module is configured to detect a failure of a storage drive of a first storage RAID storage group of the plurality of RAID groups which results in the first RAID storage group having at least two fewer redundant storage drives as compared to a second RAID storage group, and in response to detection of the failure of the first RAID storage group, select a storage drive from a second RAID storage group of the plurality of RAID storage groups, which has a plurality of redundancy levels, as a donor spare storage drive for the failed storage drive of the first RAID storage group.

### BACKGROUND

Storage resources, such as hard disk drives and solid state disks, can be arranged in various configurations for different purposes. For example, such storage resources can be configured to have different redundancy levels as part of a redundant array of independent disks (RAID) configuration. In such a configuration, the storage resources can be arranged to represent logical or virtual storage and to provide different performance and redundancy based on the RAID level.

### BRIEF DESCRIPTION OF THE DRAWINGS

Certain examples are described in the following detailed description and in reference to the drawings, in which:

FIG. 1 is an example block diagram of a storage system to provide storage processing according to an example of the techniques of the present application.

FIG. 2 is an example process flow diagram of a method of storage processing according to an example of the techniques of the present application.

FIGS. 3A-3I is another example process flow diagram of a method of storage processing according to an example of the techniques of the present application.

FIG. 4 is an example block diagram showing a non-transitory, computer-readable medium that stores instructions for a method of storage processing according to an example of the techniques of the present application.

### DETAILED DESCRIPTION OF SPECIFIC EXAMPLES

As explained above, storage resources, such as hard disk drives and solid state disks, can be arranged in various configurations for different purposes. For example, storage resources can be configured to have different redundancy levels as part of a redundant array of independent disks (RAID) configuration.

In such a configuration, the storage resources can be arranged to represent logical storage and to provide different performance and redundancy based on the RAID level. In one example, a RAID storage system may be configured as a RAID-6 system having a plurality of storage groups and with each of the storage groups having a plurality of storage drives, such as hard disk drives, solid state disks and the like, arranged to provide a multiple data redundancy arrangement. A RAID-6 storage system configuration can include a disk array storage system with block-level striping with double distributed parity and provide fault tolerance of two storage drive failures, that is, the disk array can continue to operate in a normal manner even with failure of two storage drives. This configuration can facilitate larger RAID storage group systems or configurations such as for high-availability storage systems. For example, a RAID-6 storage system having eight storage groups can include sixteen storage drives actively in use as parity storage drives when the system is operational or in a healthy condition with no storage drive failures. However, the failure of three storage drives in such a system can cause the failure of a storage drive group. To help reduce the risk of a storage group failure, the storage system can employ global hot spare storage drives which can be provisioned to immediately begin repairing portions, such as volumes, in storage drive groups with failed storage drives instead of having to wait for manual or human intervention. In one example, a RAID-6 storage system with storage resources configured as storage groups may include four global hot spare storage drives which may be globally available to replace to these storage groups. This may help improve the redundancy of the system but may increase the cost of the system because the additional global hot spare storage drives may not be actively used when the system is in an operational or healthy condition.

In one example, the techniques of the present application may help increase the overall redundancy of storage systems. For example, a storage system may be configured as a RAID-6 storage system and include a storage device configured to manage a plurality of storage groups each having a plurality of storage drives. To illustrate, it can be assumed that the storage system may have been configured with no global hot spare storage drives remaining or available for allocation or provisioned in the first place. The storage system can be configured to detect failures of storage drives from the plurality of storage drives of the storage groups. In response to failure detection, the storage system can select donor spare storage drives from one of the other storage drive groups which has two or more greater redundant storage drives as compared to the storage group with the failure and reallocate the selected drives for use in rebuilding the failed storage drives. In this manner, the system can intentionally degrade a portion or volume of the selected storage groups to provide some level of redundancy for all the storage groups. The system may help balance the redundancy of the overall system. In another example, the system may be in a condition or state in which one storage drive group may have no redundancy and another storage drive group may have dual redundancy. In this case, it may be statistically more likely for the system to encounter a data loss event or failure condition compared to a system with two storage drive storage groups with single redundancy and other storage groups with dual redundancy. In one example, a storage system with eight storage drive storage groups may allow for the potential use of eight additional storage drives to serve a purpose similar to global hot spare storage drives where such system can be used in lieu of or in combination with global hot spare storage drives.

In another example of the techniques of the present application, the storage system may be configured with greater than two redundant storage drives per storage group using techniques such as triple-parity RAID or any arbitrary technique requiring N of M data blocks (where N is less than or equal to M−2) to recover the original data. In such techniques, the storage system can categorize storage groups by their current level of redundancy and their target level of redundancy. The storage system can track status of storage drives and, when a storage group loses storage drives due to failure for example, its categorization may change. The storage system, when there is a storage groups with 2 additional redundant drives as compared to another storage group, can use this situation as an opportunity to use a donor spare storage drive to help balance the redundancy. The storage system can include control mechanisms or techniques which can be used to limit the use of donor spare storage drives to certain scenarios, such as when all redundancy has been lost. There also may be scenarios where storage groups of different redundancy levels are both candidates to receive a donor spare storage drive; in such a scenario, the storage group with less redundancy may typically be selected to receive the donor spare storage drive. The storage system may be configured to select the storage group with the largest delta or difference between the current level of redundancy and the desired level of redundancy. In one example, 3 storage groups are configured with triple parity. Further, to illustrate, one storage group loses access to 2 storage drives and another loses access to 3 storage drives. In this case the storage group which has lost access to 3 storage drives is selected to receive a donor spare storage drive from the storage group which had not lost any storage drives due to failure for example. In a similar example, 2 storage groups are configured with triple parity. Further, to illustrate, one storage group loses access to 2 storage drives and with one remaining redundant storage drive. In this case, a donor spare storage drive may be selected so that both storage groups have 2 redundant storage drives.

In one example, the techniques of the present application may provide for a storage system with a storage management module and a plurality of RAID storage groups that include storage drives with a plurality of redundancy levels. The storage management module can be configured to detect a failure of a storage drive of a first RAID storage group of the plurality of RAID storage groups that results in the first RAID storage group having at least two fewer redundant storage drives as compared to a second RAID storage group. In response to detection of the failure of the first RAID storage group, the storage management module can select a storage drive from a second RAID storage group of the plurality of RAID groups, which has a plurality of redundancy levels, as a donor spare storage drive for the failed storage drive of the first RAID storage group. In this manner, the system can help balance the redundancy of the overall system while helping to reduce the cost of the system.

In another example, the techniques of the present application describe a storage system that can handle different storage failure conditions including a predictive or predict failure. In one example, the storage system can be configured to handle storage failure conditions that include a predictive or predict fail state. In this state, the storage system may include a storage drive that is currently operational, but based on statistical information about the storage system including storage resources, the storage drive may provide information indicating that it may soon fail such as within a certain period of time. The storage system may be configured to invoke or initiate a predictive failure process or procedure which includes treating such predictive storage drive failure condition or state as a failure condition for the purpose of donor spare storage behavior. In other words, if the storage system gathers information about storage drives that indicates storage drives may fail soon, then the storage system can treat such storage drives as failed storage drives and proceed to invoke the donor spare techniques of the present application and replace these storage drives with donor spare storage drives from another storage group. Such procedures may involve donor storage drives as well as recipient storage drives. In another example, the storage system may invoke this process and initiate a rebuild process to global spare storage drives based on the predict fail condition or state. The donor spare techniques of the present application, which may be invoked or combined with the predict fail process, and if no global spares are available and the predict fail storage drive (if treated as failed) can cause the storage group to lose all redundancy, then initiate a donor spare storage drive rebuild process. From the donor spare storage drive perspective, the storage system may be configured to consider the group to not be in a healthy condition sufficient enough to be a donor storage group if one of the storage drives were in a predictive or predict failure state or condition.

In another example of the techniques of the present application, the storage management module may be further configured to accept a replacement storage drive for the failed storage drive and to rebuild data for the second RAID storage group to the replacement storage drive, allowing the first RAID storage group to retain the donor spare storage drive. In this manner, the storage system may be able to provide for “roaming spares” techniques. In another example, the storage management module may be further configured to select the second RAID storage group from a subset of the total set of storage groups based on the location of the storage group or a specified configuration of the storage system. In this manner the storage system may be able to provide techniques to adjust the scope of visibility of storage across the system. In another example, the storage management module may be further configured to treat a predictive failure condition of a drive as a true failure, select a donor spare storage drive to rebuild the contents of the storage drive with the predictive failure condition, and inhibit the selection of a second RAID storage group utilizing a storage drive with a predictive failure condition. In this manner, the storage system may be able to provide functionality for covering predictive spare rebuild techniques.

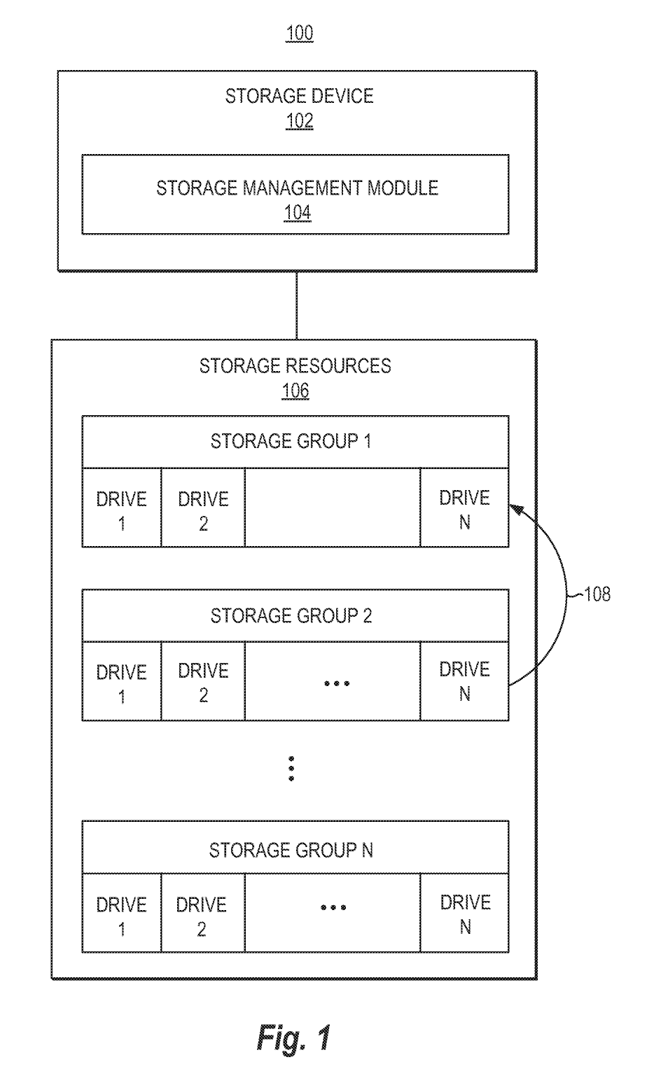

FIG. 1 is an example block diagram of a storage system 100 to provide storage processing according to an example of the techniques of the present application. The storage system 100 includes storage resources 106 communicatively coupled to storage device 102 which is configured to control the operation of storage resources. As explained below in further detail, storage device 102 includes a storage management module 104 configured to manage the operation of storage resources 106 including handling failure of storage resources and to improve overall system redundancy.

The storage resources 106 can include any storage means for storing data and retrieving the stored data. For example, storage resources 106 can include any electronic, magnetic, optical, or other physical storage devices such as hard disk drives, solid state drives and the like. In one example, storage resources 106 can be configured as a plurality of storage groups Group 1 through Group N and wherein each storage group can comprise a plurality of storage drives Drive 1 through Drive N. In one example, storage device 102 can configure storage resources 106 as a first storage group Group 1 and a second storage group Group 2. In addition, storage device 102 can configure storage group Group 1 and storage group Group 2 as a RAID storage arrangement with a plurality of storage drives having a plurality of redundancy levels and associated with respective storage drives Drive 1 through Drive N which can store parity information, such as hamming codes, of data stored on at least one storage drive. In one example, storage management module 104 can configure storage resources 106 as a RAID-6 configuration with a dual redundancy level and with storage groups Group 1 and Group 2 having six storage drives D1 through D6.

The storage management module 104 can be configured to manage the operation of storage device 102 and operation of storage resources 106. In one example, as explained above, storage management module 104 can include functionality to configure storage resources 106 as a RAID-6 configuration with a dual redundancy level with first storage group Group 1 and second storage group Group 2 with each of the storage groups having six storage drives D1 through D6. The storage management module 104 can check for failures of storage drives storage groups such as storage drives of the first RAID storage group that results in the first RAID storage group having at least two fewer redundant drives as compared to a second RAID storage group. A failure of a storage drive can include a failure condition such that at least a portion of content of a storage drive, such as a volume, is no longer operational or accessible by storage management module 104. In contrast, storage drives may be considered in an operational or healthy condition when the data on the storage drives are accessible by storage management module 104. The storage management module 104 can check any one of storage groups Group 1 and Group 2 which may have encountered a failure of any of storage drives D1 through D6 associated with respective storage groups. In one example, a failure of storage drives can be causes by data corruption such that it can cause the corresponding storage group to no longer have redundancy, in this case, no longer have dual redundancy or a redundancy level of two. In another example, storage management module 104 can be configured to detect a failure of a storage drive of a first RAID storage group of the plurality of RAID storage groups that results in the first RAID storage group having at least two fewer redundant drives as compared to a second RAID storage group

The storage management module 104 can be configured to perform a process to handle failure of storage drives of storage groups. For example, if storage management module 104 includes a process to detect whether storage group Group 1 encounters failure of storage drives D1 through D6 such that the failure causes the storage group to no longer have redundancy, in this case, no longer have a redundancy level of two (dual redundancy), then the storage management module can proceed to perform a process to handle the storage drive failure. For example, storage management module 104 can perform a process to select a storage drive from another storage group, in this case, second RAID storage group Group 2, as a donor spare storage drive for the failed storage drive of the first RAID storage group Group 1. For example, storage management module 104 can select storage drive D6 associated with storage group Group 2 as a donor spare storage drive for the failed storage drive D6 of storage group Group 1, as indicated by arrow 108. In another example, storage management module 104 can select donor spares based on other factors or criteria. For example, storage management module 104 can select a donor spare storage drive from the plurality of RAID storage groups being least likely to encounter a correlated storage drive failure based in part on physical vibration of the failed storage drive or other physical phenomenon.

The storage management module 104 can be configured to rebuild data from failed storage drives onto the selected spare donor storage drives. For example, storage management module 104 can use data from storage drives that have not failed, in this case, storage drives D1 through D5 associated with storage group Group 1, to rebuild the data of the failed storage drive, in this case, storage drive D6 associated with storage group Group 1 onto to the selected donor spare storage drive, in this case, storage drive D6 of storage group Group 2, and to calculate and store corresponding parity information of the data. In another example, storage management module 104 can include a combination of global hot spare storage drives and donor spare storage drives. In this case, storage management module 104 can assign a priority or higher precedence to the global hot spare storage drives relative to the donor spare storage drives and then select storage drives having the higher priority or precedence for use to rebuild the faded storage drives upon detection of the storage drive failures. In another example, storage management module 104 can be configured to accept replacement storage drives for the faded storage drives and then copy data from the donor spare storage drives to the replacement storage drives.

The system 100 is shown as a storage device 102 communicatively coupled to storage resources 106 to implement the techniques of the present application. However, the techniques of the application can be employed with other configurations. For example, storage device 102 can include any means of processing data such as, for example, one or more server computers with RAID or disk array controllers or like computing devices to implement the functionality of the components of the storage device such as storage management module 104. The storage device 102 can include computing devices having processors configured to execute logic such as processor executable instructions stored in memory to perform functionality of the components of the storage device such as storage management module 104. In another example, storage device 102 and storage resources 106 may be configured as an integrated or tightly coupled system. In another example, storage resources 106 can be configured as a JBOD (just a bunch of disks or drives) combined with a server computer and an embedded RAID or disk array controller configured to implement the functionality of storage management module 104 and the techniques of the present application.

In another example, storage system 100 can be configured as an external storage system. For example, storage system 100 can be an external RAID system with storage resources 106 configured as a RAID disk array system. The storage device 102 can include a plurality of hot swappable modules where each of the modules can include RAID engines or controllers to implement the functionality of storage management module 104 and the techniques of the present application. The storage device 102 can include functionality to implement interfaces to communicate with storage resources 106 and other devices. For example, storage device 102 can communicate with storage resources 106 using a communication interface configured to implement communication protocols such as SCSI, Fibre Channel and the like. The storage device 102 can include a communication interface configured to implement protocols, such as Fibre Channel and the like, to communicate with external networks including storage networks such as SAN, NAS and the like. The storage device 102 can include functionality to implement interfaces to allow users to configure functionality of the device including storage management module 104, for example, to allow users to configure the RAID redundancy of storage resources 106. The functionality of the components of storage system 100, such as storage management module 104, can be implemented in hardware, software or a combination thereof.

In addition to having storage device 102 configured to handle storage failures, it should be understood that the storage device is capable of performing other storage related functions or tasks. For example, storage management module 104 can be configured to respond to requests, from external systems such as host computers, to read data from storage resources 106 as well as write data to the storage resources and the like. As explained above, storage management module 104 can configure storage resources 106 as a multiple redundancy RAID system. In one example, storage resources 106 can be configured as a RAID-6 system with a plurality of storage groups and each storage group having storage drives configured with block level striping with double distributed parity. The storage management module 104 can implement block level striping by dividing data that is to written to storage as data blocks that are stripped or distributed across multiple storage drives. The stripe can include a set of data extending across the storage drives such as disks. In one example, data can be written to extents which may represent portions or pieces of a stripe on disks or storage drives. In another example, data can be written in terms of volumes which may represent portions or subsets of storage groups. For example, if a portion of a storage drive fails, then storage management module 104 can rebuild a portion of the volume or disk rather than rebuild or replace the entire storage drive or disk.

In addition, storage management module 104 can implement double distributed parity by calculating parity information of the data that is to be written to storage and then writing the calculated parity information across two storage drives. In another example, storage management module 104 can write data to storage resources in portions called extents or segments. For example, to illustrate, storage resources 106 can be configured to have storage groups each being associated with storage drives D1 through D5. The storage drives may be hard disk drives with sector sizes of 512 bytes. The stripe data size, which may be the minimum amount of data to be written, may be 128 kilobytes. Therefore, in this case, 256 disk blocks of data may be written to the storage drives. In addition, parity information may be calculated based on the data to be written, and then the parity information may be written to the storage drives. In case of a double parity arrangement, a first parity set is written to the storage drive and another set of the parity set may be written to another storage drive. In this manner, data may be distributed across multiple storage drives to provide a multiple redundancy configuration. In one example, storage management module 104 can store the whole stripe of data in memory and then calculate the double parity information (sometimes referred to as P and Q). The storage management module 104 can then temporarily store or queue the respective write requests to the respective storage drives in parallel, and then send or submit the write requests to the storage drives. Once storage management module 104 receives acknowledgement of the respective write requests from the respective storage drives, it can proceed to release the memory and make the memory available for other write requests or other purposes.

In another example, storage management module 104 can include global hot storage drives which can be employed to replace failed storage drives and rebuild the data from the failed storage drives. A global hot spare storage drive can be designated as a standby storage drive and can be employed as a failover mechanism to provide reliability in storage system configurations. The global hot spare storage drive can be an active storage drive coupled to storage resources as part of storage system 100. For example, as explained above, storage resources 106 can be configured as multiple storage groups with each of the storage groups being associated with storage drives D1 through D6. If a storage drive, such as storage drive D6, encounters a failure condition, then storage management module 104 may be configured to automatically start a rebuild process to rebuild the data from the failed storage drive D6 to the global hot spare storage drive. In one example, storage management module 104 can read data from the non-failed storage drives, in this case, storage drives D1 through D5, calculate the parity information and then store or write this information to the global hot spare storage drive.

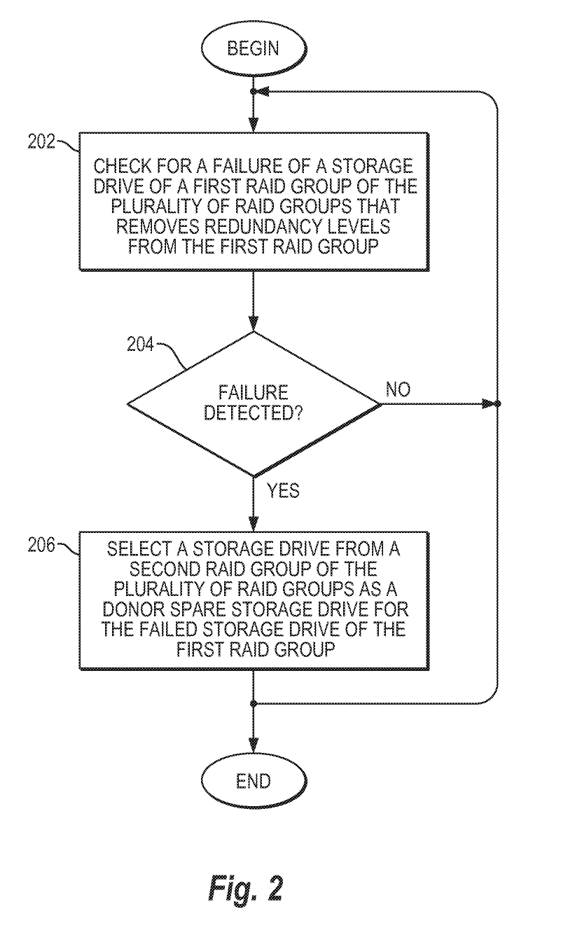

FIG. 2 is an example process flow 200 diagram of a method of storage processing according to an example of the techniques of the present application. To illustrate, in one example, it can be assumed that storage device 102 can configure storage resources 106 as a first storage group Group 1 and a second storage group Group 2. In addition, storage device 102 can configure storage groups Group 1 and Group 2 as a RAID arrangement with a plurality of storage drives having a plurality of redundancy levels (multiple redundancy arrangement) and where the storage drives can store parity information of data stored on at least one storage drive. In this example, it can be assumed that storage management module 104 can configure storage resources 106 as a RAID-6 configuration as dual redundancy (a redundancy level of two) with storage groups Group 1 and Group 2 each being associated with six storage drives D1 through D6.

The method may begin at block 202, where storage device 102 can check for failures of storage drives of a first RAID storage group that removes redundancy levels from the first RAID storage group. In one example, in a system having three redundant storage drives (triple-parity RAID), the failure can result in the first RAID storage group Group 1 having at least two fewer redundant drives as compared to second RAID storage group Group 2. In another example, storage management module 104 can check whether storage group Group 1 encountered a failure of any of storage drives D1 through D6 associated with the first storage group such that the failure caused the storage group to no longer have redundancy, in this case, no longer have a redundancy level of two. In another example, storage management module 104 can check whether second storage group Group 2 encountered a failure of any of storage drives D1 through D6 associated with the second storage group such that the failure caused the storage group to no longer have redundancy, in this case, no longer have a redundancy level of two. In addition to having storage management module 104 configured to check for storage failures, it should be understood that the storage management module is capable of performing other storage related functions or tasks. For example, storage management module 104 can respond to requests such as requests to read data from storage resources 106, requests to write data to the storage resources and the like.

At block 204, storage device 102 determines whether a failure of storage drives of the first RAID storage group occurred. For example, if storage management module 104 detects that storage group Group 1 encountered a failure of any of storage drives D1 through D6 such that the failure caused the storage group to no longer have redundancy, in this case, no longer have a redundancy level of two, then processing proceeds to block 206 below where the storage management module proceeds to handle the storage drive failures. In another example, if storage management module 104 detects that both storage drive D5 and storage drive D6 of storage group Group 1 encountered a failure, then such an occurrence would remove all redundancy from the storage group and would cause processing to proceed to block 206. Likewise, in another example, if second storage group Group 2 encountered a failure of storage drives D1 through D6 such that the failure caused the storage group to no longer have redundancy, in this case, no longer have a redundancy level of 2, then processing proceeds to block 206 below where storage device 102 proceeds to handle the storage drive failures. In another example, the failure can result in the first RAID storage group Group 1 having at least two fewer redundant drives as compared to second RAID storage group Group 2. In another example, in a system having three redundant storage drives (triple-parity RAID), the failure can result in the first RAID storage group Group 1 having at least two fewer redundant drives as compared to second RAID storage group Group 2. On the other hand, if storage management module 104 detects that only one storage drive, such as storage drive D5 of storage group Group 1, encountered a failure, then such an occurrence would not remove all redundancy from the storage group. In this case, processing proceeds back to block 202 where storage device 102 would continue to monitor or check for storage drive failures that cause redundancy to be removed from the storage groups.

At block 206, storage device 102 selects storage drives from a second RAID group as a donor spare storage drives for the failed storage drives of the first RAID storage group. Continuing with the example above, it can be assumed, to illustrate, that storage management module 104 detected that both storage drive D5 and storage drive D6 of storage group Group 1 encountered a failure which resulted in removal of redundancy from the storage group. In one example, in this case, in response to the failure, storage management module 104 can select a storage drive from another storage group, such as storage group Group 2, as a donor spare storage drive for the one of the failed storage drives of storage group Group 1. For example, storage management module 104 can select storage drive D6 of storage group Group 2 as a donor spare storage drive for storage drive D6 of storage group Group 1. In another example, storage management module 104 can select donor spares based on other factors or criteria. For example, storage management module 104 can select donor spare storage drives from the plurality of RAID storage groups being least likely to encounter a correlated storage drive failure based in part on vibration of the failed storage drives.

Continuing with this example, storage management module 104 can then use data from storage drives that have not failed, in this case, storage drives D1 through D4 of storage group Group 1, to rebuild the data of the failed storage drive, in this case, storage drive D6 of storage group Group 1 to the selected donor spare storage drive, in this case, storage drive D6 of storage group Group 2, and to calculate parity information of the data. In another example, storage system 100 can include global hot spare storage drives and storage management module 104 can assign higher priority or precedence to the global hot spare storage drives relative to donor spare storage drives when the storage management module is to make a selection of storage drives upon detection of a storage drive failures. In another example, storage management module 104 can be configured to accept replacement storage drives for the failed storage drives and copy data from the donor spare storage drives to the replacement storage drives. Once storage management module 104 selects the donor drive and rebuilds the data of the failed drives to the donor drive, processing proceeds back to block 202 where the storage management module can continue to check for storage failures and other storage related functions.

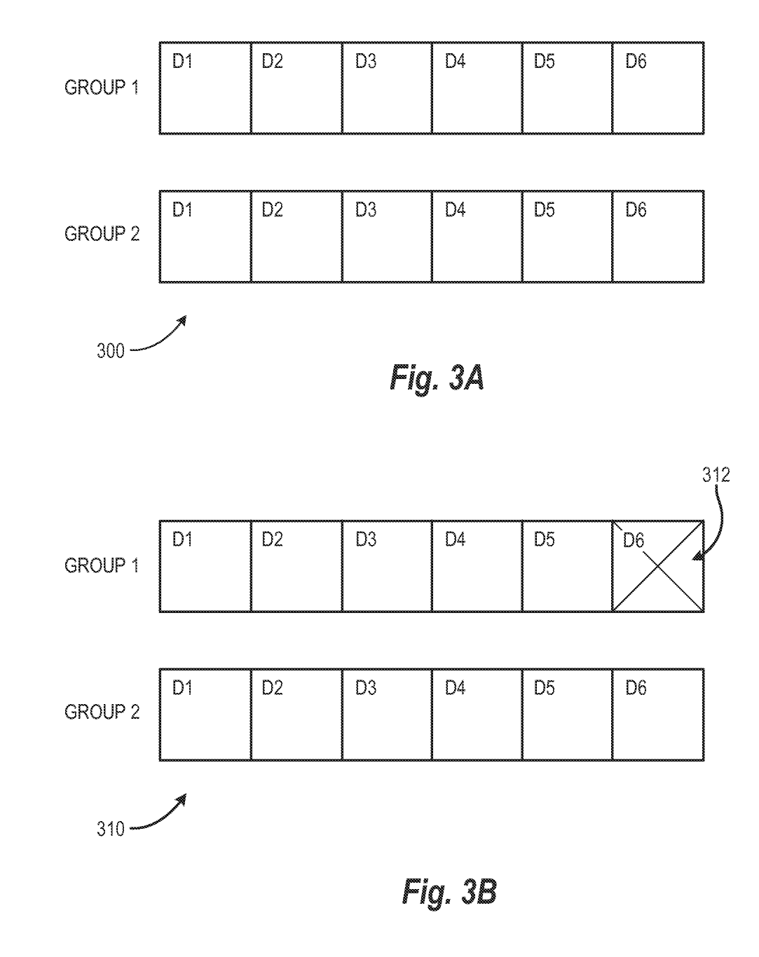

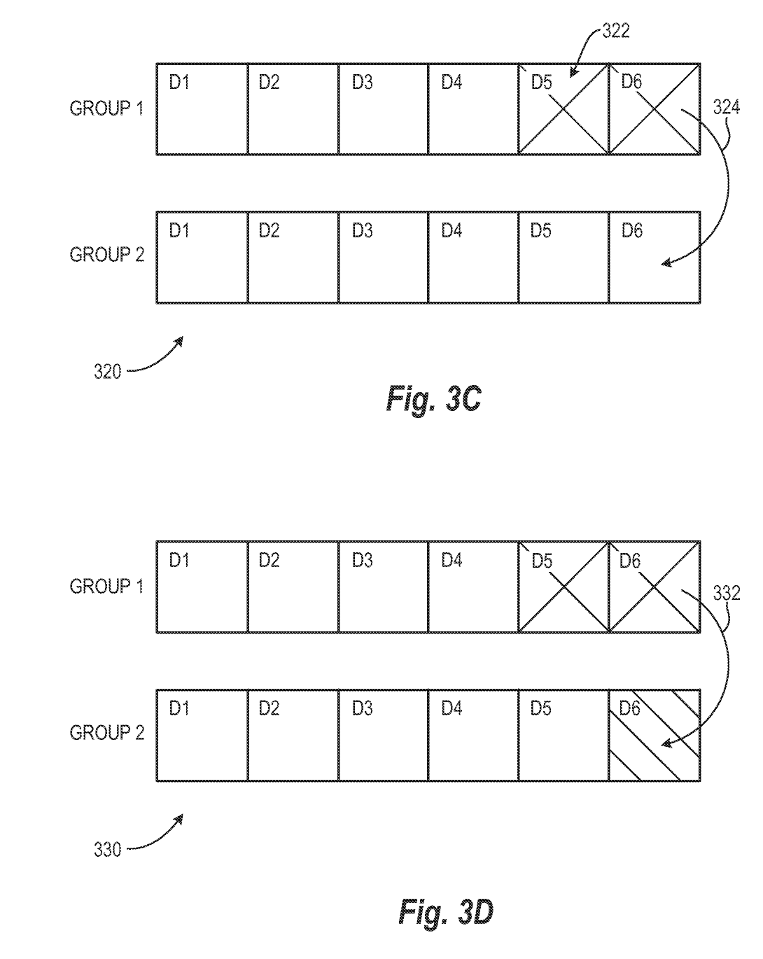

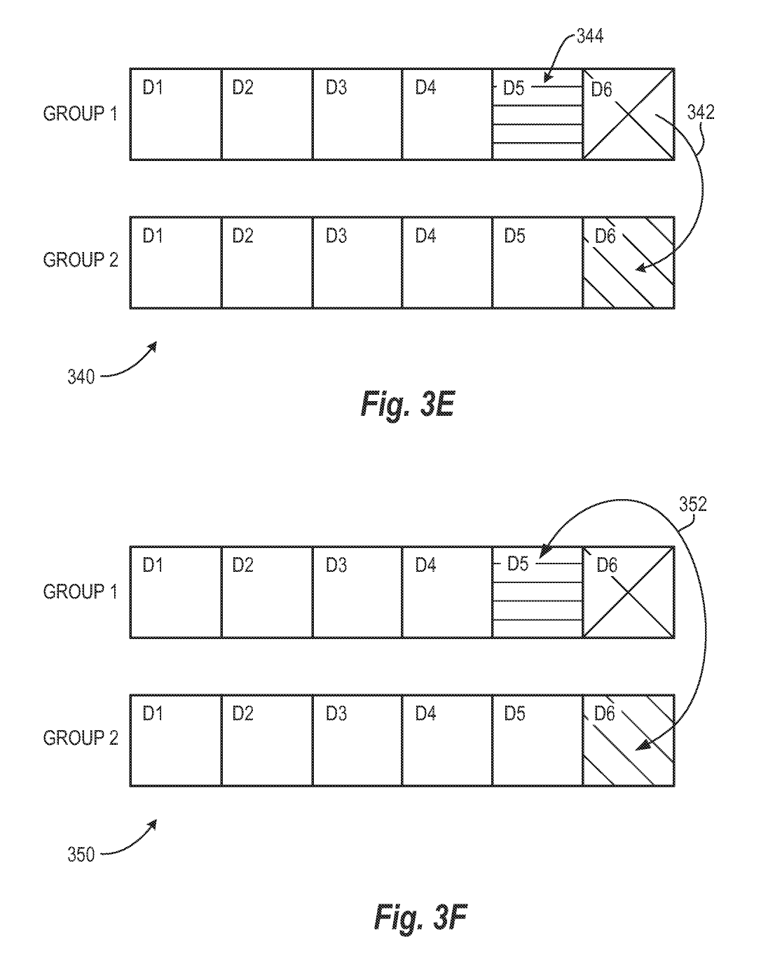

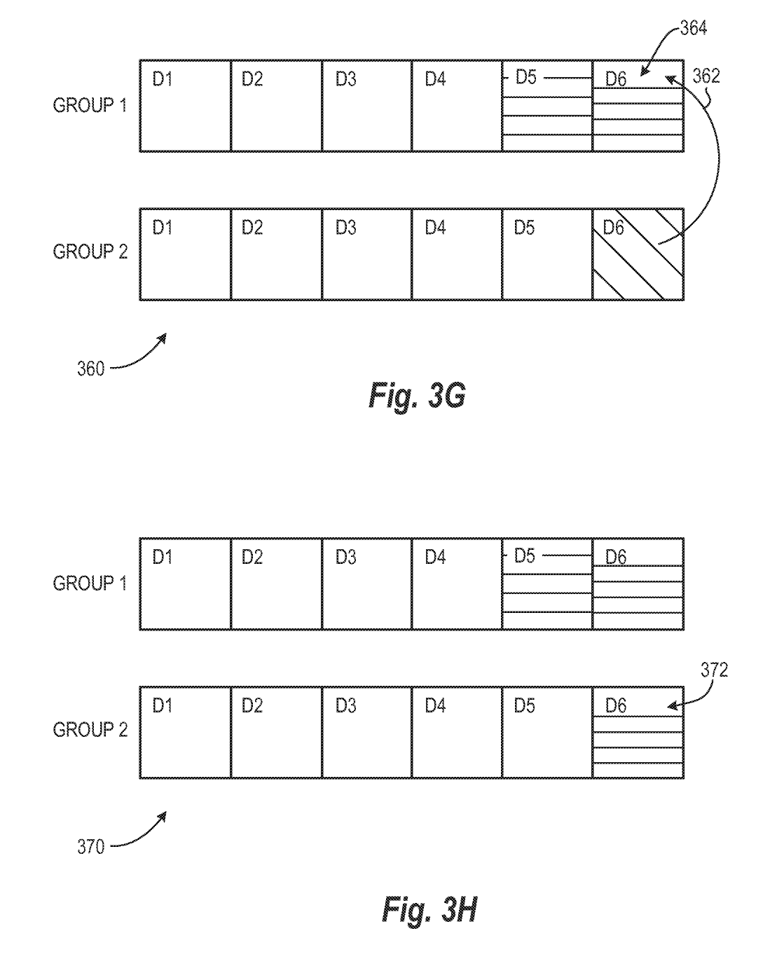

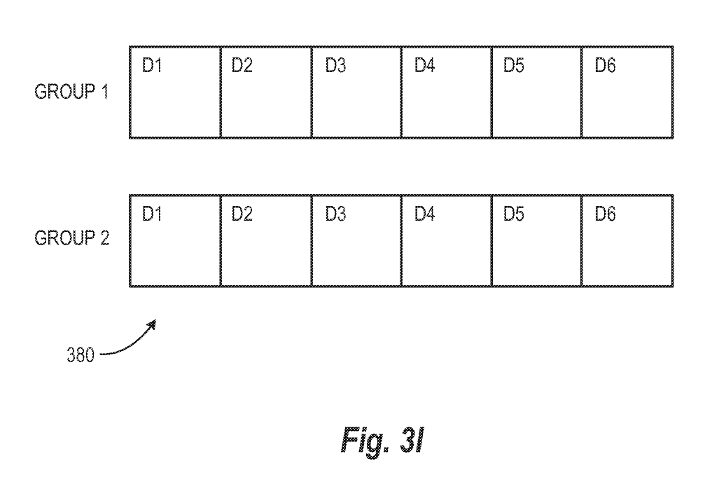

FIGS. 3A-3I is an example process flow diagram of a method of storage processing according to an example of the techniques of the present application. The example process flow will illustrate the techniques of the present application including processing failures in storage resources configured as RAID arrangements.

FIG. 3A shows an initial process block 300 in the example process flow diagram of a method of RAID storage processing. To illustrate, in one example, it can be assumed that storage management module 104 can configure storage resources 106 as first storage group Group 1 and second storage group Group 2. In addition, storage management module 104 can configure storage group Group 1 and storage group Group 2 as a RAID arrangement with a plurality of storage drives having dual redundancy (redundancy levels of two) and the storage drives can store parity information of data stored on at least one storage drive. In one example, as shown in process block 300, storage management module 104 can configure storage resources as a RAID-6 configuration with dual redundancy (redundancy level of two) with the storage groups Group 1 and Group 2 each being associated with respective six storage drives D1 through D6. To further illustrate, it can be assumed that storage management module 104 does not employ global hot spare storage drives for use as spare storage drives when storage drive failure conditions occur.

The storage management module 104 can be configured to provide redundancy parameters to assist in making decisions in selection of donor spare storage drives. For example, storage management module 104 can provide an overall minimum redundancy (OMR) parameter and an overall average redundancy (OAR) parameter. The OMR parameter can represent the minimum redundancy between the storage groups and take into consideration the amount of redundancy (redundancy levels) of the storage groups. The OAR parameter can represent the average redundancy between the storage groups and take into consideration the average of the redundancy (redundancy levels) of the storage groups. In this initial case, first storage group Group 1 has a Redundancy Level of two (2) and second storage group Group 2 has a Redundancy Level of two (2). Therefore, in this initial state, the 01\AR parameter has a Redundancy Value of two (2) and the OAR parameter has a Redundancy Value of two (2) as indicated in Table 1 below.

TABLE 1

| | Group 1 | Group 2 | |
|---|---|---|---|
| Redundancy | Redundancy | Redundancy | Redundancy |
| Parameter | Level | Level | Value |
| OMR | 2 | 2 | 2 |
| OAR | 2 | 2 | 2 |

FIG. 3B shows a subsequent process block 310 in the example process flow diagram of a method of RAID storage processing. To illustrate, it can be assumed that a storage drive of the arrangement of process block 310 encounters a failure condition. For example, to illustrate, it can be assumed that storage drive D6 of storage group Group 1 encounters a failure condition such it is no longer operational or data on the storage drive is no longer accessible by storage management module 104, as shown by arrow 312 in process block 310. In this case, the Redundancy Level of storage group Group 1 becomes a value of one (1) because of the failure of storage drive D6 of the storage group. However, the Redundancy Level of storage group Group 2 remains a value of two (2) because this storage group has not encountered a failure condition. Therefore, OMR parameter has a Redundancy Value of one (1) and the OAR parameter has a Redundancy Value of 1.5 as indicated in Table 2 below.

TABLE 2

| | Group 1 | Group 2 | |
|---|---|---|---|
| Redundancy | Redundancy | Redundancy | Redundancy |
| Parameter | Level | Level | Value |
| OMR | 1 | 2 | 1 |
| OAR | 1 | 2 | 1.5 |

In this case, storage management module 104 does not proceed to respond to the failure condition, for example, it does not select a spare donor storage drive from storage group Group 2, because any such action may not help improve the minimum redundancy of the system.

FIG. 3C shows a subsequent process block 320 in the example process flow diagram of a method of RAID storage processing. To illustrate, it can be assumed that a second or additional storage drive encounters a failure condition. For example, to illustrate, it can be assumed that storage drive D5 of storage group Group 1 encounters a failure condition such that it is no longer operational or data on the storage drive is no longer accessible by storage management module 104, as shown by arrow 322 in process block 320. In this case, the Redundancy Level of storage group Group 1 is reduced to a value of zero (0) because of the failure of storage drive D5 of the storage group and failure of storage drive D6 described above. However, the Redundancy Level of storage group Group 2 remains a value of two (2) because this storage group has not encountered a failure condition. Therefore, the Redundancy Value of the OMR parameter becomes a zero (0) and the Redundancy Value of the OAR parameter becomes a one (1) as indicated in Table 3 below.

TABLE 3

| | Group 1 | Group 2 | |
|---|---|---|---|
| Redundancy | Redundancy | Redundancy | Redundancy |
| Parameter | Level | Level | Value |
| OMR | 0 | 2 | 0 |
| OAR | 0 | 2 | 1 |

In this case, storage management module 104 proceeds to respond to the failure condition, for example, it selects a spare donor drive from storage group Group 2, because such a response may improve the minimum redundancy of the configuration of the system. In one example, storage management module 104 can select storage drive D6 of storage group Group 2 and reallocate it as a donor spare storage drive for storage group Group 1, as shown by arrow 324. In this manner, storage management module 104 can begin a process to rebuild storage group Group 1 to help improve its redundancy and the overall minimum redundancy. The storage management module 104 may initiate the rebuild process by reading the data from the storage drives that have not failed, in this case, storage drives D1 through D4 of storage group Group 1, and using that data and associated parity information to rebuild the data of failed storage drive D6 onto the donor spare storage drive, in this case, storage drive D6 of storage group Group 2. In another example, storage management module 104 can be configured in a system that does not have global hot spare storage drives or does not replace the failed storage drives which would result in the OAR parameter becoming a value of one (1).

FIG. 3D shows a subsequent block 330 in the example process flow diagram of a method of RAID storage processing. To illustrate, it can be assumed that storage management module 104 completed the process to rebuild storage drive D6 of storage group Group 1, as indicated by arrow 332. At this point in the process, the Redundancy Level of storage group Group 1 becomes a value of one (1) and the Redundancy Level of storage group Group 2 becomes a value of one (1), that is, each of the storage groups have a single level of redundancy. In this case, the Redundancy Value of the OMR parameter becomes a value of one (1) and the Redundancy Value of the OAR parameter becomes a value of one (1) as indicated in Table 4.

TABLE 4

| | Group 1 | Group 2 | |
|---|---|---|---|
| Redundancy | Redundancy | Redundancy | Redundancy |
| Parameter | Level | Level | Value |
| OMR | 1 | 1 | 1 |
| OAR | 1 | 1 | 1 |

At this point, the system can have either of the storage groups encounter storage drive failure conditions without resulting in failure of the storage groups. In one example, storage management module 104 may be configured to detect an additional storage drive failure but may not proceed to invoke the donor spare storage drive techniques of the present application. In another example, storage management module 104 can detect a storage failure in storage group Group 2 and then proceed to revoke a donor storage drive and initiate a rebuild of the original data from the failed storage drives. In this case, although this process may appear “fair” from a system perspective, it may not increase the value of the OMR parameter (because it would remain a value of 0). In addition, in this case, the system may be exposed to a period time with two storage groups having no redundancy, that is, the OAR parameter having a value of zero (0) compared to a value of 0.5.

FIG. 3E shows a subsequent block 340 in the example process flow diagram of a method of RAID storage processing. To illustrate, in one example, it can be assumed that storage drive D5 of storage group Group 1 is replaced with a replacement storage drive, as shown by arrow 344. In response to this storage drive replacement process, storage management module 104 may initiate a rebuild process by reading the data from the storage drives that have not failed, in this case, storage drives D1 through D4 of storage group Group 1, and using that data and associated parity information to rebuild the data of failed storage drive D5 onto the replacement storage drive for storage group Group 1. As a result of this process, the redundancy of the system is shown in Table 5 below.

TABLE 5

| | Group 1 | Group 2 | |
|---|---|---|---|
| Redundancy | Redundancy | Redundancy | Redundancy |
| Parameter | Level | Level | Value |
| OMR | 1 | 1 | 1 |
| OAR | 1 | 1 | 1 |

In another example, the system may be configured to rebuild storage drive D5 of storage group Group 1 and decide which extents or segment are to be rebuilt which can be based on the RAID configuration and storage drive placement or configuration in the system. In one example, storage management module 104 may be configured to rebuild the extents or segment from the donor spare storage drive first, in this case, storage drive D6 of storage group Group 2, although such a technique may seem “fair” from a system perspective, such a technique may not have immediate impact on the OAR parameter. If storage management module 104 rebuilds the extents or segments that do not exist on any storage drive first, then such process may result in an improvement of the OAR parameter to a value 1.5 at the completion of the rebuild process. Even though it may seem “unfair” for the recipient, in this case, storage group Group 1, to become fully redundant before the donor, in this case storage group Group 2, it may be desirable in terms of the overall system redundancy. Furthermore, the system may be configured to rebuild the extents or segment which may depend directly on the storage drive that is replaced, in which case it may be desirable to rebuild the donor storage drive in a subsequent step.

FIG. 3F shows a subsequent block 350 in the example process flow diagram of a method of RAID storage processing. In one example, to illustrate, it can be assumed that storage management module 104 completed the rebuild process of the replacement drive for storage drive D5 of storage group Group 1, as indicated by arrow 352. As a result of the above rebuild of storage drive D5 of storage group Group 1, the system may become more stable from a system perspective and can waft for a subsequent process or step to begin to perform a rebuild process of storage drive D6 of storage group Group 1. At this point in the process, the Redundancy Value of the OMR parameter remains a value of one (1), but the value of the Redundancy Value of the OAR parameter improves and becomes 1.5, as indicated in the Table 6 below.

TABLE 6

| | Group 1 | Group 2 | |
|---|---|---|---|
| Redundancy | Redundancy | Redundancy | Redundancy |
| Parameter | Level | Level | Value |
| OMR | 2 | 1 | 1 |
| OAR | 2 | 1 | 1.5 |

FIG. 3G shows a subsequent block 360 in the example process flow diagram of a method of RAID storage processing. In one example, to illustrate, it can be assumed that the system provides a replacement drive for storage drive D6 of storage group Group 1, as indicated by arrow 364. In addition, storage management module 104 begins a process to copy the data stored on donor spare storage drive, in this case, storage drive D6 of storage group Group 2 onto storage drive D6 of storage group Group 1, as indicated by arrow 362. If storage management module 104 did not rebuild extents on the donor spare storage drive in the previous step above, then the storage management module can proceed to perform the process to rebuild the data at this time. In this case, having the system rebuild the donor spare storage drive, in this case, storage drive D6 of storage group Group 1, may allow the system to make the donor available at the completion of the rebuild. At this point in the process, the Redundancy Value of the OMR parameter is one (1) and the Redundancy Value of the OMA parameter is 1.5, as indicated in Table 7 below.

TABLE 7

| | Group 1 | Group 2 | |
|---|---|---|---|
| Redundancy | Redundancy | Redundancy | Redundancy |
| Parameter | Level | Level | Value |
| OMR | 2 | 1 | 1 |
| OAR | 2 | 1 | 1.5 |

In another example, storage management module 104 may be configured retain and not return the donor spare storage drive, in this case storage drive D6, which was previously selected as the donor storage group, in this case, storage group Group 2. In one example, system 100 can be configured to have storage resources 106 arranged such that locations assigned to storage drives associated with particular storage groups can change over time as failures occur. This technique, which may be referred to as roaming spare storage drive technique, may help reduce the need to perform a double rebuild process when a failed storage drive is replaced. The system can allow the replacement storage drive to be directly consumed by the donor storage group. In one example, a system can be configured to employ both modes of operation.

FIG. 3H shows a subsequent block 370 in the example process flow diagram of a method of RAID storage processing. In one example, to illustrate, it can be assumed that storage management module 104 completed the rebuild process of the replacement drive for storage drive D6 of storage group Group 1, as indicated by arrow 372. At this point in the process, the Redundancy Value of the OMR parameter and the Redundancy Value of the OAR parameter have not changed from the previous step, as indicated in Table 8 below. However, the donor spare drive, in this case, storage drive D6 of storage group Group 1, now becomes available and can be returned to its original storage group, in this case, storage group Group 2. Although storage management module 104 performed an additional rebuild process that would not have been otherwise been required with the addition of a global hot spare drive, such further rebuild process may help provide redundancy to the system as a whole without any further cost in system components.

TABLE 8

| | Group 1 | Group 2 | |
|---|---|---|---|
| Redundancy | Redundancy | Redundancy | Redundancy |
| Parameter | Level | Level | Value |
| OMR | 2 | 1 | 1 |
| OAR | 2 | 1 | 1.5 |

FIG. 3I shows a subsequent block 380 in the example process flow diagram of a method of RAID storage processing. In one example, to illustrate, it can be assumed that storage management module 104 completed the rebuild process of the donor spare storage drive, in this case, storage drive D6 of storage group Group 2. At this point in the process, the overall health or redundancy of the system is improved back to the original state with the Redundancy Value of the OMR parameter returning to two (2) and Redundancy Value of the OAR parameter returning to two (2), as indicated in Table 9 below.

TABLE 9

| | Group 1 | Group 2 | |
|---|---|---|---|
| Redundancy | Redundancy | Redundancy | Redundancy |
| Parameter | Level | Level | Value |
| OMR | 2 | 2 | 2 |
| OAR | 2 | 2 | 2 |

It should be understood that the above examples are for illustrative purposes and the techniques of the present application can be employed in other configurations. For example, although the above example included storage resources configured as two storage groups with each being associated with six storage drives, the techniques of the present application can be employed with storage resources having a different number of storage groups and a different number of storage drives. In some examples, the system can be configured to employ storage resources as a combination of global hot spare storage drives and donor spare storage drives. The global hot spare storage drives may be assigned a higher priority or precedence relative to donor spare storage drives which may help reduce any temporary loss of redundancy or any additional rebuild cost. In another example, the system can employ global hot spare storage drives which may help provide systems with fully redundant storage drive groups. In yet another example, the system can employ global hot spare storage drives to rebuild failed storage drives onto the global hot spare storage drives. This may provide for systems with partially redundant storage drive groups in which the global hot spare storage drives may be reallocated to the storage drive groups with no redundancy rather than donor spare storage drives. In another example, if both of the above cases exist, then the system can select the global hot spare storage drives which may be been targeted by an in progress rebuild process since its reallocation may not result in a change in OAR redundancy parameter.

The system can be configured to implement techniques for returning selected donor spare storage drives back to the original storage drive storage group. As explained above, there may be several techniques for returning such selected donor spare storage drives. In one example, on the one hand, the system can be configured to help minimize the time spent as donor spare storage drives which may help minimize future impact of being a donor spare, that is, reduce risk of loss of all redundancy after a subsequent failure of one of the donor storage drives. In another example, on the other hand, the system can be configured to provide a global view of redundancy which can suggest against the intuitive fairness of attempting to return the donor spare storage drive back to the original storage group as soon as possible.

The system can be configured to provide different levels of scope of visibility of the donor spare storage drives. For example, in some environments, the system can include one or more physical enclosures to support storage drives and be configured to adjust or limit the scope of global hot spare storage drives to one or more “local” enclosures rather than have all of the enclosures visible to the storage device or controller. In this manner, the system can help preserve the locality of storage drive groups in part to limit the scope of any enclosure level storage drive failures. In these types of scenarios, the system can limit the scope of the donor spare storage drives to the same scope of the storage drives. In this case, the storage device or controller may be configured to manage multiple storage groups for providing donor storage drive functionality.

The system can be configured to adjust the level of participation of storage drives of storage groups. For example, the system can be configured to arrange to provide priority or the relative importance of different storage drive groups and then arrange particular storage drive groups to be completely excluded from the donor process employed by the techniques of the present application. In one example, the system can be configured to have particular storage drive groups, for example, RAID-5 configured storage drive groups, participate only as recipients of donor storage drives. In another example, if appropriate, the system can implement a level of “fairness” by providing precedence to donor storage groups over these other recipients.

The system can be configured to provide techniques for selection of donor spare storage drives. In one example, the system can be configured to select in a random manner a donor spare storage drive from any fully redundant storage drive group from the donor group to provide the donor spare storage drive. In another example, the system can be configured to provide a priority or list of storage drive groups and select in a prioritized manner such as to select a top priority storage drive group if fully redundant, and so on down the list. In another example, the system can be configured to select in a least recent manner such that it can select a storage drive from a fully redundant storage drive group that at least recently behaved as a donor spare storage group. In this manner, the techniques can provide some level of “fairness”. In another example, the system can be configured to select a storage drive group that has not contributed its fair share of being a donor over period of time or history of the system. This can occur in the case when a particular storage group has been in a degraded state while other storage drive groups were selected multiple times as donor storage groups.

The system can be configured to select donor spare storage drives based on the relative location of the donor storage drives. For example, the system can be configured to select storage drive groups whose associated storage drives may be physically distant from the location of the failed storage drives or recipients which can be help minimize the likelihood of a correlated failure affecting the donor spare storage drives. In other example, the system can identify the location of all failed storage drives in the system and make a selection based on maximizing the distance from any of those storage drives. In this manner, the system can take into account the possibility of failed, but powered on, storage drives from interacting, such as inducing vibration, to neighboring storage drives which can cause additional failures. In this type of situation, the system can select a direct neighbor as a donor storage drive which may increase the likelihood of two storage drive groups experiencing permanent failures instead of one.

In another example, the system can perform a process to select donor spare storage drives based on utilization of the storage drives. For example, the system can select a storage drive group having a capacity that is least utilized so that if that donor storage group were to suffer a subsequent failure, the exposure in terms of data lost would be minimized. The system can make this determination based on system information such as file system knowledge, thin provisioning information, or a zone based indication of which areas of the storage drive groups are in use.

The techniques of the present application may provide advantages. For example, a system can be configured to employ a combination of global hot spare storage drives and donor spare storage drives. The system can provide steady state system redundancy in storage resources configured as RAID-6 system with eight storage drive groups which can effectively provide eight global hot spare storage drives without increasing system cost. In one example, the techniques can help reduce the number of global hot spare storage drives allocated to a system, where such global hot spare storage drives can be reallocated for use as storage drives for regular use which may help reduce the cost of the system. The techniques of the present application may help improve the performance of a storage system. For example, the techniques can be employed in storage environments where RAID-6 volumes are in use which can help increase the availability and reduce the cost storage systems delivered to users or system administrators. In addition to overall donor spare storage techniques of the present application, the system can employ global hot spare storage drives to help balance the overall redundancy of the system.

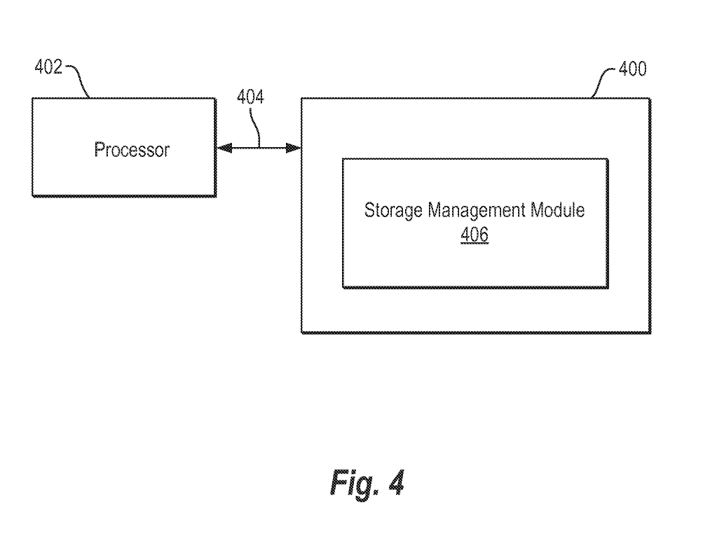

FIG. 4 is an example block diagram showing a non-transitory, computer-readable medium that stores code for operating a system for operating RAID storage processing according to an example of the techniques of the present application. The non-transitory, computer-readable medium is generally referred to by the reference number 400 and may be included in storage system described in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, solid state drives and flash memory devices.

A processor 402 generally retrieves and executes the instructions stored in the non-transitory, computer-readable medium 400 to operate the storage device in accordance with an example. In an example, the tangible, machine-readable medium 400 can be accessed by the processor 402 over a bus 404. A first region 406 of the non-transitory, computer-readable medium 400 may include functionality to implement storage management module as described herein.

Although shown as contiguous blocks, the software components can be stored in any order or configuration. For example, if the non-transitory, computer-readable medium 400 is a hard drive, the software components can be stored in non-contiguous, or even overlapping, sectors.

What is claimed is:

1. A storage system to process storage, the system comprising:
a plurality of redundant array of independent disks (RAID) storage groups comprising storage drives to have a plurality of redundancy levels; and
a storage management module to:
detect a failure of a storage drive of a first RAID storage group of the plurality of RAID storage groups that results in the first RAID storage group having at least two fewer redundant storage drives as compared to a second RAID storage group, and
in response to detection of the failure of the first RAID storage group, select a storage drive from a second RAID storage group of the plurality of RAID storage groups, which has a plurality of redundancy levels, as a donor spare storage drive for the failed storage drive of the first RAID storage group.

2. The storage system of claim 1, wherein the storage management module is further configured to accept a replacement storage drive for the failed storage drive and to rebuild data for the second RAID storage group to the replacement storage drive, thereby allowing the first RAID storage group to retain the donor spare storage drive.

3. The storage system of claim 1, wherein the storage management module is further configured to assign higher precedence to a global hot spare storage drive relative to a donor spare storage drive when the storage management module is to make a selection of a storage drive upon detection of a failure of the first RAID storage group.

4. The storage system of claim 1, wherein the storage management module is further configured to use data from storage drives that have not failed to rebuild the data of the failed storage drive to the selected donor spare storage drive and to calculate parity information of the data.

5. The storage system of claim 1, wherein the storage management module is further configured to accept a replacement storage drive for the failed storage drive and to copy data from the donor spare storage drive to the replacement storage drive.

6. The storage system of claim 1, wherein the storage management module is further configured to select the donor spare storage drive from the plurality of RAID storage groups being least likely to encounter a correlated storage drive failure based in part on vibration of the failed storage drive.

7. A method for processing storage, the method comprising:
a storage management module configuring storage drives of a plurality of redundant array of independent disks (RAID) storage groups to have a plurality of redundancy levels;
the storage management module detecting a failure of a storage drive of a first RAID storage group from the plurality of RAID storage groups which results in the first RAID storage group having at least two fewer redundant storage drives as compared to a second RAID storage group; and
in response to detection of the failure which results in the first RAID storage group having at least two fewer redundant storage drives as compared to a second RAID storage group, the storage management module selecting a storage drive from a second RAID storage group of the plurality of RAID storage groups, which has a plurality of redundancy levels, as a donor spare storage drive for the failed storage drive of the first RAID storage group.

8. The method of claim 7, wherein the storage management module further configured for accepting a replacement storage drive for the failed storage drive and rebuilding data for the second RAID storage group to the replacement storage drive, thereby allowing the first RAID storage group to retain the donor spare storage drive.

9. The method of claim 7, wherein the storage management module is further configured for using data from storage drives that have not failed for rebuilding the data of the failed storage drive to the selected donor spare storage drive and calculating parity information of the data.

10. The method of claim 7, wherein the storage management module is further configured for assigning higher precedence to a global hot spare storage drive relative to a donor spare storage drive when the storage management module is to make a selection of a storage drive upon detection of a failure of the first RAID storage group.

11. The method of claim 7, wherein the storage management module is further configured for accepting a replacement storage drive for the failed storage drive and copying data from the donor spare storage drive to the replacement storage drive.

12. A non-transitory computer-readable medium having computer executable instructions stored thereon to process storage, the instructions are executable by a processor to:
configure storage drives of a plurality of redundant array of independent disks (RAID) storage groups to have a plurality of redundancy levels;
detect a failure of a storage drive of a first RAID storage group from the plurality of RAID storage groups which results in the first RAID storage group having at least two fewer redundant storage drives as compared to a second RAID storage group; and
in response to detection of the failure which results in the first RAID storage group having at least two fewer redundant storage drives as compared to a second RAID storage group, select a storage drive from a second RAID storage group of the plurality of RAID storage groups, which has a plurality of redundancy levels, as a donor spare storage drive for the failed storage drive of the first RAID storage group.

13. The non-transitory computer readable medium of claim 12, further comprising instructions to cause the processor to accept a replacement storage drive for the failed storage drive and to rebuild data for the second RAID storage group to the replacement storage drive, allowing the first RAID storage group to retain the donor spare storage drive.

14. The non-transitory computer readable medium of claim 12, further comprising instructions to cause the processor to use data from storage drives that have not failed to rebuild the data of the failed storage drive to the selected donor spare storage drive and calculating parity information of the data.

15. The non-transitory computer readable medium of claim 12, further comprising instructions to cause the processor to assign higher precedence to a global hot spare storage drive relative to a donor spare storage drive when the storage management module is to make a selection of a storage drive upon detection of a failure of the first RAID storage group.
